(19) United States
(12) Patent Application Publication
(10) Pub. No.: US 2015/0021368 A1
(43) Pub. Date: Jan. 22, 2015

(54) Wheelbarrow Support Strap

(71) Applicant: Gary Nilsen, Redmond, WA (US)

(72) Inventor: Gary Nilsen, Redmond, WA (US)

(21) Appl. No.: 13/948,034

(22) Filed: Jul. 22, 2013

(51) Int. Cl. B62B 5/06; A45F 3/14

(52) U.S. Cl. CPC B62B 5/068; A45F 3/14; A45F 2003/148
USPC 224/257

(57) ABSTRACT

The instant application discloses, among other things, a Wheelbarrow Support Strap. The instant application discloses, among other things, a Wheelbarrow Support Strap. In one embodiment, Wheelbarrow Support Strap 100 may comprise a strap with a first end and second end. Each end may have an attachment means comprising a cylindrical or tube-shaped grip configured to receive the end of a handle shaft. In another embodiment, the Wheelbarrow Support Strap may include an adjustment means, for example, a buckle, which may allow the laborer to keep the strap taut while operating the wheelbarrow. The adjustment means may be located on the strap or on an attachment means, for example, on a handle grip, to facilitate adjustment of the strap length while the wheelbarrow is in use.

### FIELD

This disclosure relates to an accessory for wheelbarrows, and more specifically, a Wheelbarrow Support Strap.

### BACKGROUND

Wheelbarrows are hand-propelled vehicles that allow a user to transport a load of materials such as tools or yard waste over a relatively short distance. They are commonly used by laborers in the fields of gardening, farming, and construction. A conventional wheelbarrow includes at least one wheel at its front end, an axle assembly, a bin, two legs, and two handle shafts at its rear.

Most wheelbarrows are designed to distribute the weight of its load between its front wheel section and the user. Because the operator must grasp and lift the wheelbarrow's handles to maneuver it, the operator's hand, arm, shoulder, and back muscles often become strained or sore. In addition, because the wheel section is typically located in front, most wheelbarrows easily tip to one side or the other when it they are in use. The laborer must exert significant effort and strength to keep the wheelbarrow stabilized when operating the vehicle. This balancing effort often causes considerable upper body fatigue in the laborer.

### SUMMARY

The instant application discloses, among other things, a Wheelbarrow Support Strap. In one embodiment, Wheelbarrow Support Strap 110 may comprise of a strap with a first end and second end. Each end may have an attachment means comprising, for example, a cylindrical or tube-shaped grip configured to receive the end of a handle shaft. In another embodiment, the attachment means may be loops, S-hooks, snap hooks, bolt plates, anchor plates, J-hooks, flat hooks, ratchet fasteners, over-center fasteners, slide buckles, and snap buckles. A person skilled in the art will understand that a grip may be made of rubber, foam, silicone, gel, plastic, leather, or any other material.

In another embodiment, the Wheelbarrow Support Strap may comprise a strap equipped with a retraction assembly, for example, a retractable reel that is secured to the strap and which contains a cable reel that connects to the wheelbarrow handle grip. The wheelbarrow assembly may allow the laborer to keep the strap taut while operating the wheelbarrow, as a loose strap would fail to upwardly distribute the weight of the wheelbarrow's load away from the handles and relieve the laborer of upper body fatigue. The retraction assembly may allow the user to adjust the strap length using only one hand. In another embodiment, the retractable reel may be located on the strap's attachment means, for example, the handle grip, to facilitate adjustment to the strap length while the wheelbarrow is in use. In yet another embodiment, the Wheelbarrow Support Strap may have a shock absorbing means attached to each of the first end and the second end, which may provide shock absorption, and may relieve fatigue in the user. The shock absorbing means may comprise, for example, a retraction assembly, an extension spring, or a hydraulic damper. One having skill in the art will recognize that other forms of shock absorbing means may be used.

In yet another embodiment, the Wheelbarrow Support Strap may comprise a strap with a single or plurality of retractable ratchets, for example, two ratchets on opposite ends of the strap.

A person skilled in the art will understand that Wheelbarrow Support Strap may be comprised of any material such as nylon, polypropylene, polyester, webbing, mesh, cotton, spandex, rubber, rope, or cable. One having skill in the art will also recognize that Wheelbarrow Support Strap 100 may be made in various shapes, sizes, and colors, and may have different ways of adjusting length.

### BRIEF DESCRIPTION OF THE DRAWINGS

FIG. 1 is a perspective view of a Wheelbarrow Support Strap, according to one embodiment.

FIG. 2 is a perspective view of a Wheelbarrow Support Strap, according to another embodiment.

FIG. 3 is a perspective view of a Wheelbarrow Support Strap, according to another embodiment.

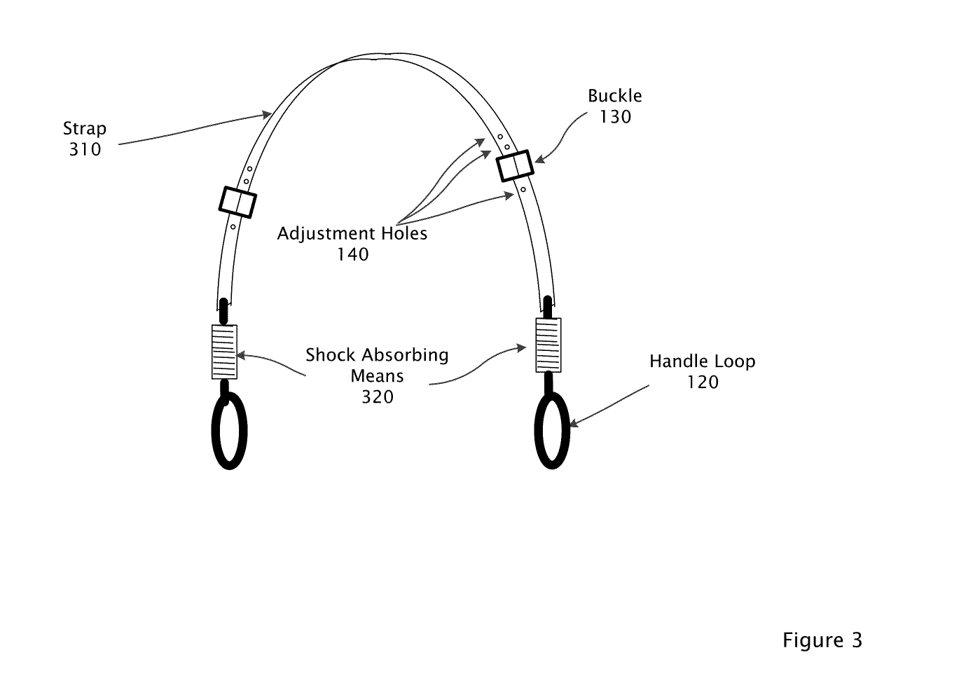

FIG. 4 is a side view of an exemplary wheelbarrow operator using a Wheelbarrow Support Strap, according to one embodiment.

FIG. 5 illustrates one embodiment of Wheelbarrow Support Strap 110 used with a Securing Mechanism 420.

Like reference numerals are used to designate like parts in the accompanying drawings.

### DETAILED DESCRIPTION

A more particular description of certain embodiments of Wheelbarrow Support Strap may be had by references to the embodiments shown in the drawings that form a part of this specification, in which like numerals represent like objects.

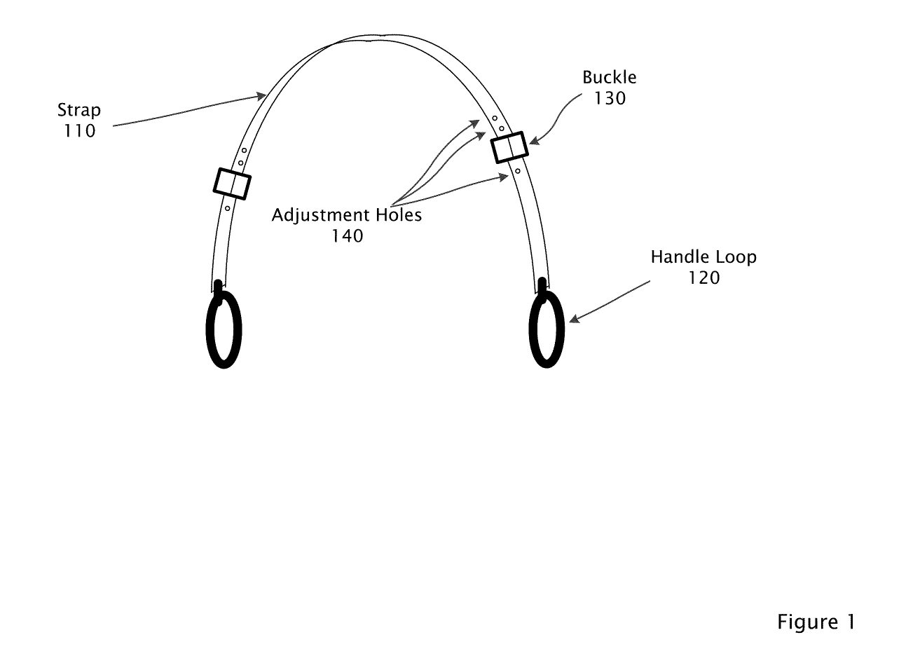

FIG. 1 is a perspective view of a Wheelbarrow Support Strap 100, according to one embodiment. In this example, Wheelbarrow Support Strap 100 may comprise a Wheelbarrow Support Strap 110 having a first end and second end. Each end may have a Handle Loop 120, configured to easily slip over a wheelbarrow's handle. Wheelbarrow Support Strap 110 may be placed over a person's neck, which may help distribute any forces involved in lifting the wheelbarrow handle and moving the wheelbarrow between the person's hands and shoulders. This may allow a person to handle heavier or more awkward loads than they may unassisted. Handle Loop 120 may be held in place on a wheelbarrow handle by hands of an operator, or may be kept in place by a catch means, such as a peg or hook, which may provide a more secure coupling to the wheelbarrow handle.

One or both ends of Wheelbarrow Support Strap 110 may have an adjustment means to lengthen or shorten a working range of Wheelbarrow Support Strap 110. As an example, a fastening means may comprise Buckle 130, which may adjust to various Adjustment Holes 140. In other embodiments, an adjustment means may comprise hook and loop fasteners, spring-loaded retraction devices, a peg, bolt, or other device through corresponding Adjustment Holes 140, friction-based strap adjuster, or other forms of adjusters known in the industry. In another embodiment, Wheelbarrow Support Strap 110 may be of a fixed size, with no adjustment for length. In yet another embodiment, Wheelbarrow Support Strap 110 may have portions that may stretch, configured to prevent excessive force on a user's neck and shoulders. One having skill in the art will recognize that there are many ways to adjust a strap.

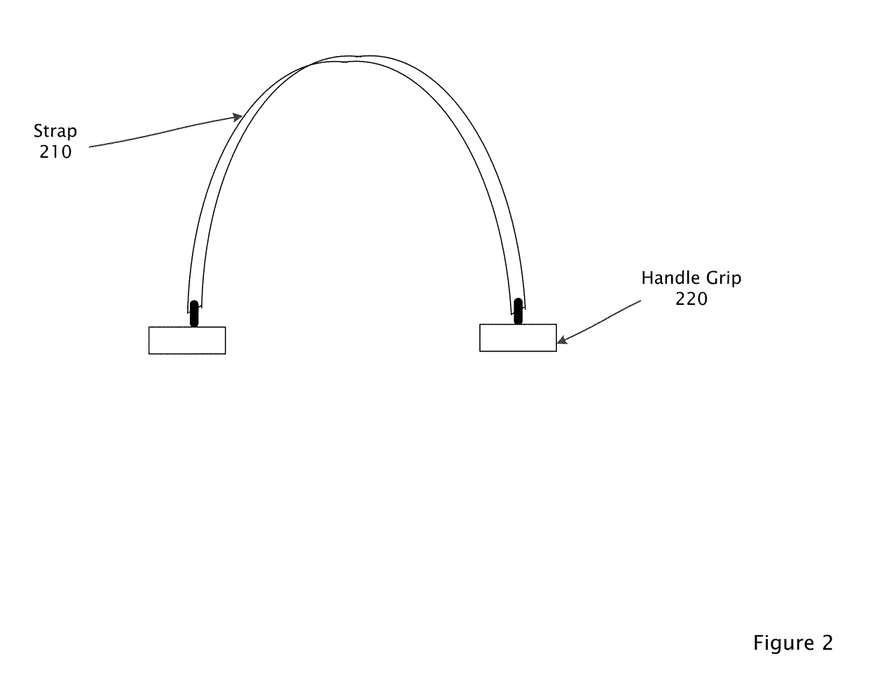

FIG. 2 is a perspective view of a Wheelbarrow Support Strap 210, according to another embodiment. In this embodiment, Wheelbarrow Support Strap 210 may have an attachment means on each end comprising a cylindrical or tube-shaped Handle Grip 220 configured to receive and support an end of a wheelbarrow handle shaft.

Handle Grip 220 may include an ergonomic cushion to minimize fatigue on the laborer's hands and absorb shock. Handle Grip 220 may include any means to provide friction, for example, indentations, to keep the user's hand from slipping. A person skilled in the art will understand that a Handle Grip 220 may be made of rubber, foam, silicone, gel, plastic, leather, or any other material and may provide cushion for the user's hands.

FIG. 2 is a perspective view of a Wheelbarrow Support Strap 310, according to another embodiment. Shock Absorbing Means 320 may be springs, hydraulic shock absorbers, or retractable reel. Shock Absorbing Means 320 may provide shock absorption, and may relieve fatigue in the user.

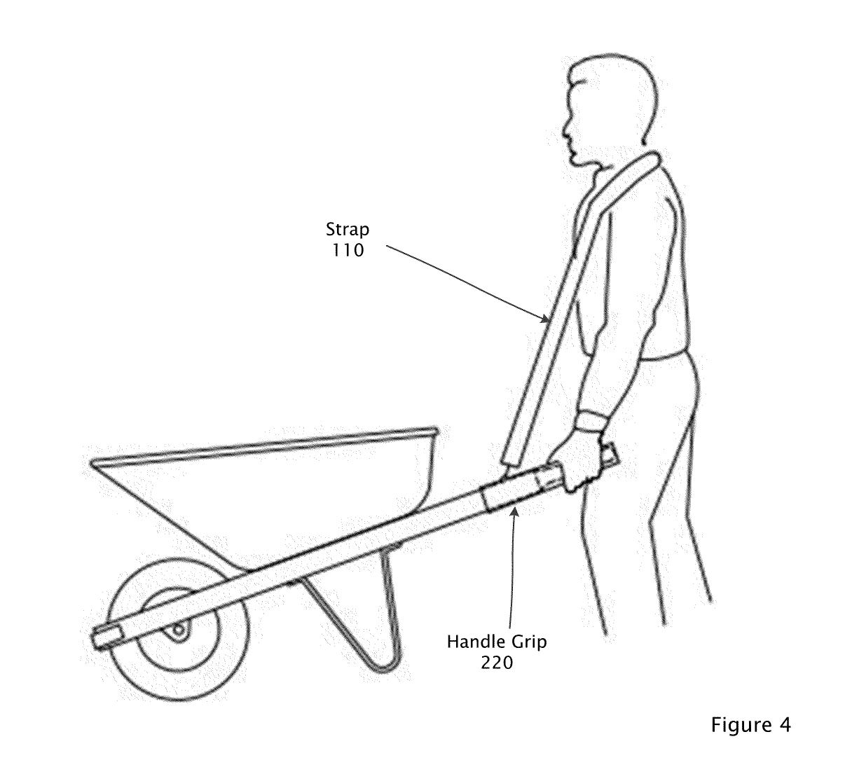

FIG. 4 is a side view of a wheelbarrow operator using a Wheelbarrow Support Strap 110, according to one embodiment.

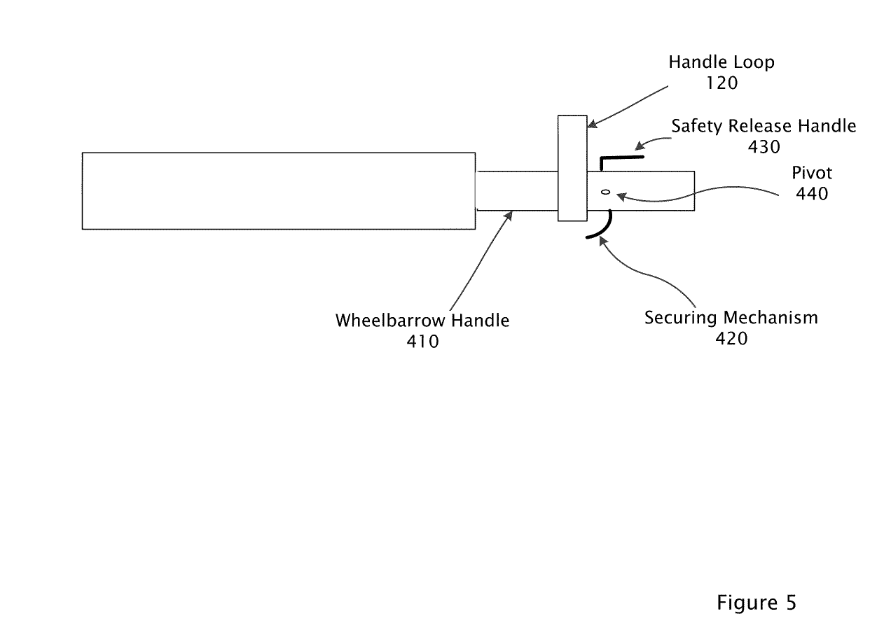

FIG. 5 illustrates one embodiment of Wheelbarrow Support Strap 110 used with a Securing Mechanism 420. Securing Mechanism 420 may assist an operator by keeping Handle Loop 120 in a preferred location on Wheelbarrow Handle 410. Safety Release Handle 430 may allow an operator to easily allow Handle Loop 120 to slip off Wheelbarrow Handle 410 in the event of a wheelbarrow becoming unbalanced or uncontrollable. In this example, Safety Release Handle 430 may be held by the operator while gripping Wheelbarrow Handle 410. Safety Release Handle 430 may be coupled to Securing Mechanism 420, and they may pivot at Pivot 440. If the operator releases the grip, Safety Release Handle 430 may be permitted to rise, which may allow Securing Mechanism 420 to pivot back, allowing Handle Loop 120 to freely slip off Wheelbarrow Handle 410. One having skill in the art will recognize that other means may be used as a safety release, such as a spring loaded peg which retracts upon a touch by an operator, a peg designed to break if a force pushing on it exceeds a threshold, or a hook configured to bend and release Handle Loop 120 upon application of a force exceeding a threshold.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A wheelbarrow support strap, comprising:
a strap, the strap having a first end and a second end, the first end having a first attachment means configured to engage a first wheelbarrow handle, and a second attachment means configured to engage a second wheelbarrow handle; and
an adjustment means for adjusting a length of the strap.

2. The wheelbarrow support strap of claim 1, wherein the strap is made from one or more materials selected from the group containing nylon, polypropylene, polyester, webbing, mesh, cotton, spandex, rubber, rope, or cable.

3. The wheelbarrow support strap of claim 1 wherein the first and second attachment means comprise a generally cylindrical shape.

4. The wheelbarrow support strap of claim 1 wherein the adjustment means comprises a buckle configured to fit in holes in the strap.

5. The Wheelbarrow Support Strap of claim 1 wherein the first and second attachment means are loops configured to fit over wheelbarrow handles.

6. The wheelbarrow support strap of claim 5, further comprising a safety release coupled to a wheelbarrow handle, configured to allow a quick release of the wheelbarrow support strap from the wheelbarrow handle.

7. A wheelbarrow support strap, comprising:
a strap, the strap having a first end and a second end, the first end having a first attachment means configured to engage a first wheelbarrow handle, a second attachment means configured to engage the a second wheelbarrow handle, the first and second attachment means selected from a group containing loops, S-hooks, snap hooks, bolt plates, anchor plates, J-hooks, flat hooks, ratchet fasteners, over-center fasteners, slide buckles, and snap buckles.

8. The wheelbarrow support strap of claim 6, further comprising a safety release coupled to a wheelbarrow handle, configured to allow a quick release of the wheelbarrow support strap from the wheelbarrow handle.

9. The wheelbarrow support strap of claim 7, further comprising a shock absorbing means attached to the first end and the first attachment means.

10. The wheelbarrow support strap of claim 9 wherein the shock absorbing means is selected from the group consisting of a retraction assembly, an extension spring, and a hydraulic shock absorber.
